(19) United States
(12) Patent Application Publication
(10) Pub. No.: US 2009/0317544 A1
(43) Pub. Date: Dec. 24, 2009

(54) Method and Device for Gasodynamically Marking a Surface with a Mark

(75) Inventors: Yury V. Dikun, Moscow (RU); Vladimir I. Fedotov, Podolsk (RU); Sergey S. Tsaregorodtsev, Odintsovo district (RU)

Correspondence Address: HOUSTON ELISEEVA, 4 MILITIA DRIVE, SUITE 4, LEXINGTON, MA, 02421, US

(73) Assignee: ZAO "INTERMETCOMPOSIT", Moscow (RU)

(21) Appl. No.: 12/121,117

(22) Filed: May 15, 2008

(51) Int. Cl. B05D 1/12; B05C 19/02

(52) U.S. Cl. 427/185; 118/308

(57) ABSTRACT

The invention relates to the field of powder materials coatings, in particular the introduction of material powder particles in a pulse mode to the surface layers of production. The invention can be used in various industries to give the surface specific physical and chemical characteristics, as well as for causing spot-markers on the surface of the production with the aim of their further identification, including new developed DNA-methods. The method proposed here is the method of causing markers on the surface Gasodynamically, which is described further: disperse gas powder dredge by supersonic gas jet in the booster channel and subsequent causing the powder from the gas powder dredge on the surface that is to be marked. At the same time the supersonic gas jet is supplied to the boost channel from the supersonic nozzle, in which the compressed gas is supplied from the source of gas. Gas powder dredge is fed to the booster channel from the ejection chamber in the form of a swirl through the annular gap formed by external surface of the supersonic nozzle and internal surface of the ejection chamber. Also the device for causing spot-markers on the marking surface Gasodynamically, which is proposed, is also described further: boost channel and ejection chamber are coaxial and conjugated hermetically and in the place of this conjugation, the inner surface of this conjugation forms annular gap with outer surface of supercritical part of supersonic nozzle, powdered material batcher formed by sectional and hermetically conjugated case and lid, and inside it is fitted with U-shaped curved tube performed as split through U-shape curve and fitted with aperture in the area adjacent to the inner part of the lid.

### FIELD OF THE INVENTION

The invention relates to the field of powder materials coatings, in particular the introduction of material powder particles in a pulse mode to the surface layers of production. The invention can be used in various industries to give the surface specific physical and chemical characteristics, as well as for causing convex, flat or concave spot-markers suitable for the recognition of different readers on the surface of the production with the aim of their further identification, including new developed DNA-methods.

### BACKGROUND OF THE INVENTION

The essence of DNA (Digital Nano Authentification) described in international patent application, published under the number WO2006119561, and lies in marking with the purpose of authenticating goods, production or parts of it, made of metal, glass, plastics, ceramics, composite or other hard materials with micro- or nano-particles bearing code information which can be read by non-destructive methods of optical control. One of possible ways of causing spot-markers to the surface mentioned is Gasodynamic method.

There are different ways and devices of causing various powders from different substances and their mixtures to the surface of production that has different configuration and made of various materials by Gasodynamic method. For instance, they are described in patents and patent applications with following numbers RU2082823, CA2057448, EP0484533, U.S. Pat. No. 5,302,414, U.S. Pat. No. 6,402,050, WO9119016.

The essence of Gazodynamic method of spraying powders consists in causing particles of these powders raced by supersonic gas jet to the surface of the production. As a result of impact of particles of powder, raced by supersonic gas jet, with the surface of the production, you are able to create both layers completely covered by spraying material, and layers with separate particles of spraying powder material embedded to the surface. These layers can be flat, concave or convex on the surface.

Devices of Gazodynamic powder spraying integral parts are supersonic nozzle, the source of compressed gas, powder material batcher and input device of spraying powder to the supersonic gas jet.

The disadvantages of known methods and devices of Gazodynamic powder spraying, especially concerning DNA—methods, are:

1. All of them are designed for spraying coating to the surface of products of a various size, and usually have a great performance. In fact they are installations, composed of several functional blocks and it is virtually impossible to create portable devices of haversack type with autonomous power supply and a source of compressed gas.

2. Inability to work in a pulse mode with a small residual momentum Delay, resulting in substantial loss of powdered material and also in pickuping powders across the path passing powders from the batcher of powdered material to supersonic jet, which in turn leads to rapid failure of devices for Gazodynamic spraying and primarily due to the fact that the parameters of supersonic nozzle cease to be calculated.

3. Inability to work in a pulse mode with the possibility of adjusting small servings of powdered materials in impulse applied as a marker without changing the design calculation of supersonic nozzle.

### SUMMARY OF THE INVENTION

Technically oriented problem that is solved by this invention was to create a method and apparatus causing small powder material controlled servings for convex, flat and concave surfaces of a small, strictly limited area on the surface of all sizes and materials, in particular, coatings applied through the template, as well as coatings masking small portion of the above named material caused by powder but not impede readability and/or optical recognition of these materials radiation or other methods of non-destructive testing. At the same time devices, realizing the above possibilities could be portable, simple and reliable in operation, could be easily retargeted in the transition from one type of powder to another, and from one type of caused markers to another.

The essence of the way of causing tags for marking the surface of Gazodynamic method, proposed as an invention, is to disperse gas powder dredge by supersonic gas jet in the booster channel and subsequent causing the powder from the gas powder dredge to the surface that is to be marked. At the same time the supersonic gas jet is fed to the boost channel from the supersonic nozzle, in which the compressed gas is fed from the source of gas. Gas powder dredge is fed to the booster channel from the ejection chamber in the form of a swirl through the annular gap formed by external surface of the supersonic nozzle and internal surface of the ejection chamber at the place of its connection with the case of the booster channel. Gas powder dredge is fed to the ejection chamber from the powdered material batcher with ejection way.

In addition, compressed gas can be fed to the supersonic nozzle in a pulse way.

In addition, gas powder dredge can be fed to the ejection chamber tangentially to the internal surface of the ejection chamber.

In addition, compressed gas to withdraw from the booster channel can have the temperature in the range of 1 to 500° C.

In addition, the quantity of gas powder dredge that is supplied to the booster channel can be adjusted by the duration of impulse of feeding compressed gas to the supersonic nozzle.

In addition, the quantity of gas powder dredge that is supplied to the booster channel can also be adjusted by controlling changes in pressure between the gas pressure in the ejection chamber and gas pressure in the powdered material batcher.

In addition, as the gas fed to the supersonic nozzle, can be used any non-inflammable and non-inert gases and/or their mixture.

In addition, as the gas fed to supersonic nozzle, can be used air.

In addition, as the gas fed to supersonic nozzle, can be used overheated steam.

The essence of the way of causing tags for marking the surface of Gazodynamic method, proposed as an invention, is that the device includes booster channel, ejection chamber, supersonic jet, source of compressed gas, powdered material batcher; so that coaxial boost channel and ejection chamber are conjugated hermetically. Supersonic nozzle is situated partly inside the ejection chamber, coaxial to it, and conjugated with it hermetically with the formation of an annular gap in the supercritical part of supersonic nozzle in the place where booster channel and ejection chamber are conjugated. Input of supersonic nozzle is conjugated with source of compressed gas so that compressed gas can be fed to the input of supersonic nozzle; powdered material batcher formed by sectional and hermetically conjugated case and lid, and internally fitted with a U-shaped curved tube with a in- and outlet parts which are hermetically built-in to the lid in such way, that the outlet part of the tube forms hermetical conjugation with ejection chamber; U-shaped curved tube at the bottom of batcher performed as split through U-shape curve, and its input part is fitted with a hole in the area abut on internal surface of lid.

In addition, source of compressed gas can be fitted with the heater of compressed gas, which is supplied to supersonic nozzle.

In addition, source of compressed gas can be fitted with the device of pulse supplying of compressed gas to supersonic nozzle.

In addition, source of compressed gas can be fitted with the device of control over the pressure of compressed gas supplied to supersonic nozzle.

In addition, ejection chamber can be formed by cylindrical and conical parts, that have coaxial and hermetical conjugation.

In addition, U-shape tube conjugation with ejection chamber can be performed tangentially to the internal surface of the ejection chamber cylindrical part.

In addition, U-shape curved tube input part can be supplied with device, which can control the feeding of ejection gas to the batcher of powdered material.

In addition, ejection chamber conjugation with supersonic nozzle can be performed as sectional.

In addition, ratio of internal diameter cut of supersonic jet to the internal diameter of the booster channel may be selected in the interval from 0.8 to 0.95.

In addition, the ratio of internal diameter booster channel to its length may be selected in the interval from 0.05 to 0.08.

In addition, booster channel, ejection chamber, supersonic jet and powdered material batcher may be performed in materials, not entering into chemical interaction with compressed gas and/or the environment.

In addition, the source of compressed gas may be connected to the device that controls the feeding of ejection gas to the batcher of powdered material.

Technical result, achieved by proposed inventions, is that the way and on its basis portable device of haversack type was established. It is used for spraying spot-markers on the surface for marking it Gasodynamicly with autonomous power and a source of compressed gas, where in a pulse mode residual momentum Delay is minimized. It permitted to eliminate pickuping of spraying materials on supersonic nozzle channel, what in turn eliminated the possibility of changing its parameters during operation. Moreover, this has done extremely economical device in relation to the nonproductional loss of spraying powders. This effect is achieved mainly by sharing batcher of powdered material and split U-shape tube, by ejection supplying of gas powder dredge to special ejection chamber and by disperse gas powder dredge until the desired speed in the booster channel.

In addition, in produced device besides controlling the amount of spraying powder, an opportunity appears: to regulate the amount of ejection powder supplied into the ejection chamber through changing the amount of gas supplied to batcher of gas powder material. This leads to the change in Gas pressure difference in the batcher and in ejection chamber. This allows you to change the amount of powdered material in impulse, without exceeding the estimated parameters of supersonic nozzle. And this allows causing different spot-markers of equally high quality on the surfaces of production, without changing supersonic nozzle.

In addition, the availability of gas main and conjugation of source of compressed gas with the device that controls ejection gas feeding to the batcher of powdered material allows the device to operate, as in the airless space and in buildings with a special gas atmosphere.

In addition, gas powder dredge leading-in into booster channel from swirl ejection chamber through the annular gap between the external cut surface of supersonic nozzle and inner cut surface of ejection chamber in the place where it conjugates with booster channel. This allows to create jet consisting of gas powder dredge with uniform density of powder in cross-section jet, providing even distribution of powder on the surface of the spot-marker.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

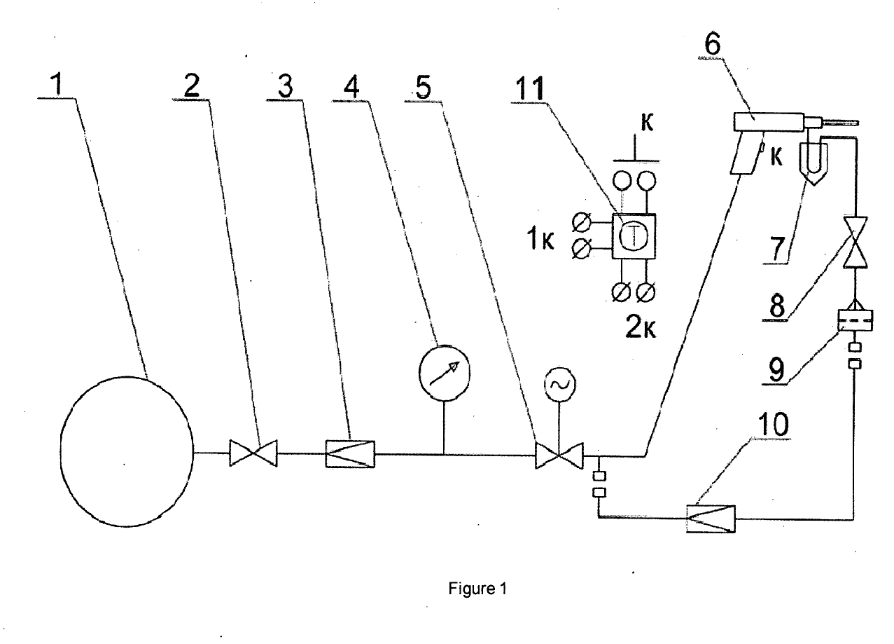

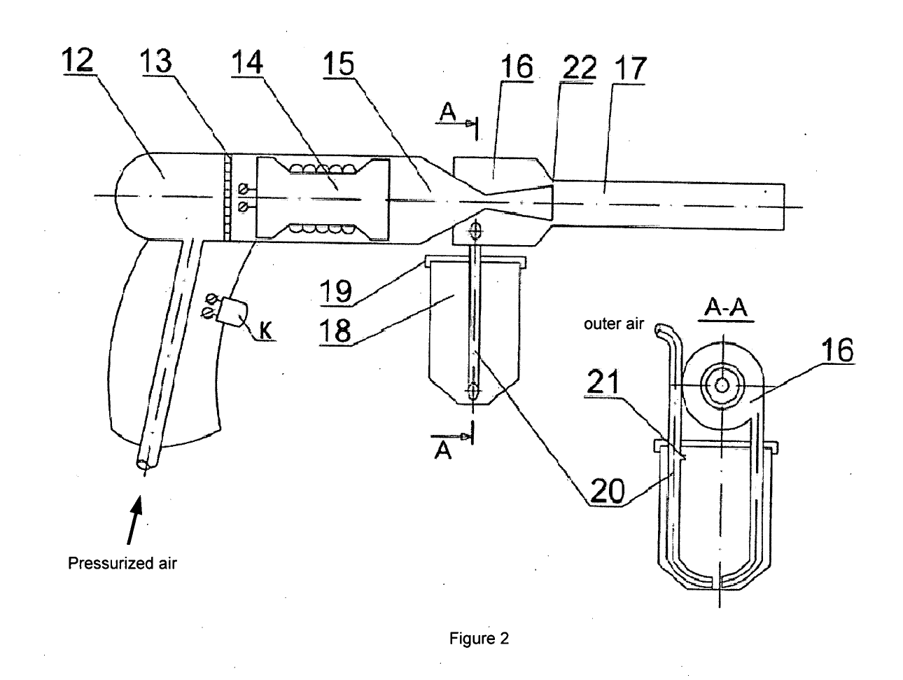

The essence of the invention explained on the FIGS. 1 and 2, while on the first one the device general scheme is presented, on the second—spraying unit of the device.

### DETAILED DESCRIPTION OF THE PREFERRED EMBODIMENTS

Device for causing markers Gasodynamically on the surface includes tank of compressed gas (1) (for example, compressed gas cylinder, compressor receiver and so on), stop-valve (2), reducer lowering the gas pressure (3), pressure gage (4), electromagnetic valve (5) normally closed, spraying unit (6), bather (7) of powdered material, regulating valve (8), filter (9), consume decreasing reducer (10), time relay (11) (timer circuit T) that has two electrical circuit exits.

Spraying unit (6) consists of case (12), perforated washer (13), gas heater (14), supersonic nozzle (15), ejection chamber (16), booster channel (17), batcher (7) of powdered material, formed by sectional and hermetically conjugated case (18) and lid (19), U-shape curved tube (20) with aperture (21), annular gap (22) between the outer surface of the outer cut of supersonic nozzle (15) and internal surface of the ejection chamber (16).

At the same time, U-shaped curved tube at the bottom of batcher performed as split through U-shape curve. This cut divides the tube (20) on the out- and inlet parts hermetically incorporated in the lid of batcher (19). At the same time, inlet part of U-shape tube (20) is fitted with aperture (21) in the area, adjacent to the inner surface of the lid.

Ejection chamber (16), booster channel (17), U-shape curved tube (20) and the batcher of powdered material (7) constitute a single replaceable unit. In addition hermetic and sectional conjugation of case (18) and lid (19) of the batcher make the case sectional, too.

It should be noted that the elements forming the source of compressed gas in this version of the device implementation are compressed gas tank (1), stop-valve (2), reducer lowering the gas pressure (3), pressure gage (4), electromagnetic valve (5), perforated washer (13), gas heater (14) and elements of gas fitting that connect them.

The method of causing spot-markers for marking the surface Gasodynamically as follows:

After gas under pressure, temperature and the expenditures required for supersonic nozzle to work under rated conditions, is supplied to the entrance of supersonic nozzle (15), supersonic gas jet, going out the supersonic nozzle, hits the booster channel (17). At that, discharge appears in the ejection chamber (16) due to annular gap (22), and because of this discharge pressure difference appears in ejection chamber (16) and in the batcher of powdered material (7). This leads to the fact that the flow of gas through the adjusting opened valve (8) and through U-shaped curved tube (20) is formed. This flow of gas through a cut in the bend of U-shaped curved tube (20) seizes powder, charged in the batcher of powdered material, and ejects it to the ejection chamber (16). In ejection chamber (16) a swirl of gas-powder dredge is formed, which through the annular gap (22) proceeds to the booster channel (17), where it is “picked up” by supersonic gas jet flowing from supersonic nozzle (15), gathers speed in the booster channel (17) and then particles of powder boosted up to necessary speed are caused on the necessary spot on the surface.

Let's consider your device causing spot-markers for marking the surface Gasodynamically in a pulse mode with heated working gas (for example, air).

Open the split lid (19) hermetically connected to the case (18) of the batcher and in- and output parts of U-shaped suction pipe (20). Sleeps in the case (18) of the batcher required amount of powdered material for causing spot-markers on the production. Connect the device to the tank (1) of compressed gas and electricity. Open the stop-valve (2), compressed natural gas comes at reducer lowering the gas pressure (3). Underweight to the working pressure, registered with pressure gage (4), gas supplied to the electromagnetic valve (5) normally closed. Push button “K”, time relay (timer T) snaps into action, and supplies electric signal on the first channel 1K to lodge electrical energy to the gas heater (14). A timer T given time, an appropriate time to release heat conditions, timer T supplies electric signal on the second channel 2K to open the electromagnetic valve (5) normally closed, and gas at a given pressure comes into the internal cavity of the case (12), passes through holes of perforated washer (13), and while it flows along the gas heater (14) it heats up to the temperature necessary for the introduction of particles of powdered material, boost up to the supersonic speed in the supersonic nozzle (15) moves through the booster channel (17), accumulating on the surface of the production. While gas moves from supersonic nozzle (15) to the booster channel (17) that disperses particles, in the ejection chamber discharge up to 0.8 atmospheres appears. When adjusting valve (8) is open, air is ejected through the filter (9) to the U-shaped curved tube (20), and in tube's lower split part picks up powdered material particles forming gas-powder dredge and transporting it to the ejection chamber through the tangential channel, which is formed by upper output part of U-shaped curved tube (20), i.e. tangentially to the inner surface of the ejection chamber

While flowing through U-shaped curved tube (20), gas with the help of aperture (21) aligns pressure above the surface of powder charged into the batcher of powdered material (7), with the pressure of gas intake. The rotating gas-powder dredge in ejection chamber (16) through the annular gap (22), formed by inner convergent part of the ejection chamber (16) and walls of accelerating particles booster channel (17), is supplied to the accelerating particles booster channel (17), is mixed up, heated and dispersed by supersonic gas jet up to the temperature and speed, needed for causing spot-markers made of particles of sprayed material on the surface of the production. The amount of incoming gas-powder dredge from the batcher depends not only on the duration of the electric pulse given to electromagnetic valve (5) normally closed and controlled by time relay (11) (Timer T), (Timer T in this case plays the role of the batcher of powdered material), but also it depends on fine adjustments of powder material portion intake for one pulse, which provides adjusting valve (8), which decreases the amount of air suction from atmosphere. As the amount of intake air decreases and fewer gas-powder dredge is transported, which leads to a reduction of powdered material potion for the same time, set by the Timer T. Upon the expiration of a specified time, Timer T sends a signal to disable the filing of electrical energy to the gas heater (14), and to close electromagnetic valve (5) normally closed. This makes it possible to cause spot-markers with strictly dosed amount of powdered material. The size and configuration of spot-markers depend on the square and configuration of flow section cut of the accelerating particles booster channel (17), and the thickness of the spot-markers depends on how long the electromagnetic valve (5) normally closed, is opened.

This process is necessary for causing convex spot-markers on the surface of products made from various materials. As materials for applying markers granular powder metals and their alloys are used, and also oxides, nitrides, borides, mineral dyes, fluorescent, radioactive materials and mechanical mixtures of these materials in various combinations for one another. As a material of products on the surface of which markers are being caused, may be any solid material: metals and alloys, ceramics, glass, plastics, organic compounds, construction, composite materials and other solids. It should be noted that the above powder materials and supplies products are not limited to these listed examples.

Let's consider this device in a pulse mode without heating gas (such as air).

Connection of the device to energy and the withdrawal of pressure on the regime of working gas are described earlier.

With the help of Timer T disable the supply of electric signal on the first channel 1K to lodge electrical energy to the gas heater (14). Through the channel 2K assign the Open-time status of the electromagnetic valve (5) normally closed. Close contacts by pressing the button “K”, time relay (11) (Timer T) snaps into action and supply electric signal to the opening of the electromagnetic valve (5) normally closed. Compressed gas under pressure is supplied to the spraying unit (6), particles in the booster channel (17) are dispersed up to the speed, necessary for the implementation process, and then sent to the surface of products, the implementation of powdered material into the surface of products happens.

The ejection portion of powdered material is determined by an open state of the electromagnetic valve (5) normally closed and adjustment valve (8). Electromagnetic valve (5) normally closed upon the expiration of the specified by timer T time, closes. The process of causing markers with particles of powder material completed.

This process is needed in cases of causing flat and/or concave spot-markers in a single layer on the surface of products, made of not heat-resistant materials, or in cases of implementation of particles, whose firmness is significantly higher than firmness of product material. As materials for causing spot-markers in a layer we use oxides, nitrides, borides, metals and their alloys with increased firmness, fluorescent or radioactive materials.

Let's consider work of the device in the version designed for running the device as in the airless space and also in buildings with a special gas atmosphere. Let's specifically consider the performance of the device in a pulse mode with heating of working gas. We'll use nitrogen as working gas.

Connect the device to the source of compressed nitrogen and electrical energy. Connect over electromagnetic valve (5) normally closed additional pneumatic tube with consume decreasing reducer (10). Ask consume decreases reducer 10 parameters for ejection of necessary portion of gas-powder dredge into the ejection chamber (16). When pressing K, in addition to the process described earlier, compressed gas (nitrogen) through the additional pneumatic tube and consume decreasing reducer (10), the filter (9) and adjustment valve (8) is supplied to the batcher of powdered material (7) using U-shaped curved tube (20). Further process described in the options discussed above.

The method and device realizing it allow the creation of autonomous device of a haversack type. In this case as a possible energy it is possible to use, for example, balloon with compressed non-inflammable gas (air, nitrogen, etc.) and the accumulator battery with 12-24V voltage, or any other autonomous source of electricity supply.

Examples of implementation of the invention.

1. Causing a spot-marker on the surface of glassware, with compressed air heating.

Fall asleep in the batcher of powder material (7) mechanical mixture of powders, for example: aluminum 90% with particle-size distribution 20-60 microns and 10% silicon dioxide with particle-size distribution 1-20 microns. Connect the device to energy source. Adjust at time relay (11)(timer T) on the first channel 1K switched with gas heater (14) 5 seconds-time, and on the second channel 2K switched with electromagnetic valve (5) normally closed, 0.2 second-time. Let's place the cut of the accelerating particles booster channel (17) on the distance about 15-20 mm from the chosen area for causing a spot-marker on the surface of production, made of glass. Push button K, timer T starts working. Time of out for heat treatment and maintaining it at a given temperature range depends on used fuel elements and ranges within the limits of few seconds. Using the heater with power of 1.5 kW, time is 5 sec, time of causing a marker is 0.2 seconds after which the Timer T deactivates, the process is terminated. The thickness of the spot-marker made of cooked mixture is about 100 microns. The amount of powdered material spent, taking into account the loss, is about 0.01 g and diameter of the spot is about 5 mm. To change the thickness of the spot-marker you should change the time while electromagnetic valve (5), assigned by Timer T, stay open, or to change the flow of gas-powder ejection dredge with the help of adjustment valve (8).

2. Pulse implementation of particles in a single layer, without gas to be heated on the working surfaces made of metal.

Fall asleep in the batcher of powder material (7), for example, silicon dioxide with particle-size distribution 10-30 microns. Connect the device to energy source. Adjust at time relay (11)(timer T) on the second channel 2K, 0.2 second-time of open-state of electromagnetic valve (5), normally closed. Place the cut of the accelerating particles booster channel (17) on the distance about 15-20 mm from the chosen area for causing a spot-marker on the surface of production, made of metal (for example, steel), and push the button “K”. Electromagnetic valve (5) normally closed opens and compressed gas is supplied to the spraying unit (6), through U-shaped curved tube suction tube (20) in intakes gas-powder dredge, accelerates it in accelerating particles booster channel (17) and injects them into the surface of processed products in a single layer. The whole process runs for 0.2 seconds. Amount of embedded powdered material, taking into account the losses, is 0.008 g where the spot diameter is about 5 mm. Working gas is not heated.

3. Causing spot-markers with heated nitrogen gas to the surface of titanium products.

Fall asleep in the batcher of powder material (7) mechanical mixture of aluminum 70% with particle-size distribution 20-60 microns and 10% silicon dioxide with particle-size distribution 1-20 microns and dye 20% (ochre) with particle-size distribution 1-20 microns. Connect additional tube to output of electromagnetic valve (5) and input of adjustment valve (8) through consume decreasing reducer (10) and filter (9). Connect the device to the energy source, adjust on the executive mechanisms (lowering reducers 3 and 10, time relay 11) the necessary parameters for causing markers on the surface of product made of titanium. Place the cut of the accelerating particles booster channel (17) on the distance about 15-20 mm from the chosen area and push the “k” button, time relay (11) (Timer T) snaps into action. During 6 seconds fuel element (gas heater) (14) goes on heat treatment, then electromagnetic valve (5) normally closed snaps into action, compressed gas nitrogen applies to spraying unit (6), where it is heated to the desired temperature and accumulates on the surface of products from the booster channel (17). When electromagnetic valve (5) normally closed snaps into action, compressed nitrogen gas, mentioned earlier, through additional pneumatic tube applies to the consume decreasing reducer (10) set to nitrogen gas ejection to the batcher of powdered material (18) and supplying of gas-powder to the booster channel (17). Further process of causing a marker described earlier. Amount of embedded powdered material, taking into account the losses, is 0.012 g, with marker thickness of about 100 microns and spot diameter about 5 mm.

4. Causing markers with heated compressed air to the surface of the concrete products.

Fall asleep in the batcher of powder material (7) mechanical mixture of 20% copper with particle-size distribution 10-30 microns, 70% aluminum with particle-size distribution 20-60 microns, 10% silicon dioxide with particle-size distribution 1-20 microns. Connect the device to the energy source. Further process is similar to the process of causing markers on the glass (example 1). Amount of embedded powdered material, taking into account the losses, is 0.015 g, with marker thickness of about 100 microns and spot diameter about 5 mm.

5. Causing convex readable spot-markers through the template on copper surfaces.

Make the template of sheet steel with thickness 0.8-1.0 mm, in which the slotted part made in the form of any mark or word. Fall asleep in the batcher (7) mechanical mixture of powders, for example, 30% zinc and 70% aluminum with particle-size distribution 20-60 microns. Adjust at time relay (11)(timer T) on the first channel 1K 5 seconds-time, and on the second channel 2K depending on the spraying surface area of the sign or the word, (for example, IMK-1500-L), 8-second time. Connect the device to the energy source and spray the coating through the template. After removing the template we can read the convex inscription of a light gray color about 500 microns thick. Increasing time on the second channel 2K allows using of the device in the mode of spraying. In case of using fluorescent or radioactive contaminants powders, placard or sign is visually readable and in the volume of caused layer coating bear code information, which can be read by non-destructive methods of control.

While this invention has been particularly shown and described with references to preferred embodiments thereof, it will be understood by those skilled in the art that various changes in form and details may be made therein without departing from the scope of the invention encompassed by the appended claims.

1. A gas-dynamic method of superimposing markers on a surface of an associated object comprising the steps of:
feeding a gas powder dredge to an ejection chamber from a powdered material batcher by means of ejection;
feeding the gas powder dredge from the ejection chamber to a booster channel in a form of a swirl;
feeding a supersonic gas jet to the booster channel via a supersonic nozzle from a source of compressed gas;
accelerating the gas powder dredge in the booster channel by virtue of the supersonic gas jet; and
superimposing a powder on a surface of an associated object from the gas powder dredge;
wherein the gas powder dredge is supplied to the booster channel to the ejection chamber via an annular gap formed by an external surface of the supersonic nozzle and an internal surface of the ejection chamber, the annular gap being positioned in an engagement area of the booster channel body and the ejection chamber.

2. The method of claim 1, wherein compressed gas is supplied to the supersonic nozzle pulsewise.

3. The method of claim 1, wherein gas powder dredge is supplied to the ejection chamber tangentially with respect to the internal surface of the ejection chamber.

4. The method of claim 1, wherein the compressed gas withdrawn from the booster channel has a temperature in a range of 1 to 500° C.

5. The method of claim 2, wherein a quantity of the gas powder dredge that is supplied to the booster channel is adjusted by controlling a duration of an impulse of feeding the compressed gas to the supersonic nozzle.

6. The method of claim 1, wherein the quantity of gas powder dredge that is supplied to the booster channel is adjusted by controlling a pressure difference between a gas pressure in the ejection chamber and a gas pressure in the powdered material batcher.

7. The method of claim 2, wherein the quantity of gas powder dredge that is supplied to the booster channel is adjusted by controlling a pressure difference between a gas pressure in the ejection chamber and a gas pressure in the powdered material batcher.

8. The method of claim 1, wherein non-inflammable and non-inert gases and/or their mixtures are used as the gas supplied to the supersonic nozzle.

9. The method of claim 1, wherein air is used as the gas supplied to supersonic nozzle.

10. The method of claim 1, wherein an overheated steam is used as the gas supplied to the supersonic nozzle.

11. A device for superimposing markers on a surface of an associated object by virtue of a gas-dynamic method, the device comprising:
a booster channel;
an ejection chamber;
a supersonic gas jet;
a source of compressed gas; and
a powdered material batcher;
wherein the booster channel and the ejection chamber are coaxial and are engaged hermetically;
wherein the supersonic nozzle is situated partly inside the ejection chamber, coaxial to it, and engaged with the ejection chamber hermetically forming thereby an annular gap in the supercritical part of the supersonic nozzle in an engagement area of the booster channel and the ejection chamber;
wherein an input of the supersonic nozzle is engaged with the source of compressed gas configured such that compressed gas is capable of being fed to the input of the supersonic nozzle;
wherein the powdered material batcher is formed by a body and a lid, the body and the lid being detachably and hermetically engaged;
wherein the powdered material batcher further comprises an internally fitted U-shaped curved tube with an inlet and an outlet parts, which are hermetically mounted into the lid such, that the outlet part of the U-shaped curved tube forms a hermetical engagement with the ejection chamber;
wherein the U-shaped curved tube at the bottom of powdered material batcher is split along the U-shaped curve; and
wherein the input part of the U-shaped curved tube comprises an aperture in the area abutting an internal surface of the lid.

12. The device of claim 11, wherein the source of compressed gas comprises a heater of compressed gas for heating the compressed gas fed to the supersonic nozzle.

13. The device of claim 11, wherein the source of compressed gas further comprises a device for supplying the compressed gas pulsewise to supersonic nozzle.

14. The device of claim 11, wherein the source of compressed gas further comprises a control device to control a pressure of the compressed gas supplied to supersonic nozzle.

15. The device of claim 11, wherein the ejection chamber is formed by a cylindrical part and a conical part, which parts are coaxial and hermetically engaged.

16. The device of claim 11, wherein the U-shape tube is engaged with the ejection chamber tangentially to the internal surface of the cylindrical part of the ejection chamber.

17. The device of claim 15, wherein the U-shape tube is engaged with the ejection chamber tangentially to the internal surface of the cylindrical part of the ejection chamber.

18. The device of claim 11, wherein the input part of the U-shape curved tube comprises a device for controlling feeding of ejected gas to the batcher of powdered material.

19. The device of claim 11, wherein the ejection chamber is detachably engaged with the supersonic nozzle.

20. The device of claim 11, wherein a ratio of an internal diameter of the supersonic jet to an internal diameter of the booster channel is in a range of 0.8 to 0.95.

21. The device of claim 11, wherein a ratio of the internal diameter of the booster channel to the length of the booster channel is in a range of 0.05 to 0.08.

22. The device of claim 11, wherein the booster channel, the ejection chamber, the supersonic jet and the powdered material batcher are made from materials that do not enter into a chemical interaction with compressed gas and/or the environment.

23. The device of claim 18, wherein the source of compressed gas is connected to a device that controls feeding of the ejection gas to the powdered material batcher.
